(19) United States
(12) Patent Application Publication
(10) Pub. No.: US 2026/0188743 A1
(43) Pub. Date: Jul. 2, 2026

(54) NON-AQUEOUS ELECTROLYTE, ELECTROCHEMICAL APPARATUS, AND ELECTRONIC APPARATUS

(71) Applicant: NINGDE AMPEREX TECHNOLOGY LIMITED, Ningde City (CN)

(72) Inventors: Junfei Liu, Ningde City (CN); Meirong Wang, Ningde City (CN); Shaoyun Zhou, Ningde City (CN); Hui Cui, Ningde City (CN)

(73) Assignee: NINGDE AMPEREX TECHNOLOGY LIMITED, Ningde City (CN)

(21) Appl. No.: 19/437,962

(22) Filed: Dec. 31, 2025

(30) Foreign Application Priority Data
Jan. 2, 2025 (CN) 202510005835.4

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0028; H01M 2300/0037

(57) ABSTRACT

A non-aqueous electrolyte includes a first substance and a second substance. The first substance includes at least one of dimethyl carbonate or ethyl acetate. Based on total mass of the non-aqueous electrolyte, a mass percentage of the first substance is M₁%, where 50≤M₁≤70. The second substance includes at least one of succinonitrile, glutaronitrile, or adiponitrile. Based on the total mass of the non-aqueous electrolyte, the mass percentage of the second substance is M₂%, where 0.01≤M₂≤3.

### CROSS REFERENCE TO THE RELATED APPLICATIONS

This application claims the benefit of priority from the Chinese Patent Application No. 202510005835.4, filed on Jan. 2, 2025, the entire content of which is incorporated herein by reference.

### TECHNICAL FIELD

The present application relates to the field of energy storage technologies, and in particular to a non-aqueous electrolyte, an electrochemical apparatus, and an electronic apparatus.

### BACKGROUND

Electrochemical apparatuses serving as power sources for electronic products are playing an increasingly important role. As one of important components of the electrochemical apparatuses, physicochemical properties of the electrolyte directly affect discharge performance of the electrochemical apparatus. Linear carbonates are widely used as non-aqueous solvents in electrolytes due to their good solubility and ultra-low viscosity, but linear carbonates are prone dehydrogenation to generate hydrogen ion that can destroy the structure of positive electrode materials and corrode negative electrode current collectors. Therefore, improving electrochemical performance of the electrolytes with linear carbonates has become an urgent priority.

### SUMMARY

Embodiments of the present application provide a non-aqueous electrolyte, an electrochemical apparatus, and an electronic apparatus, which improve cycling life while also mitigating the self-discharge phenomenon of batteries.

According to a first aspect, embodiments of the present application provide a non-aqueous electrolyte including a first substance and a second substance; the first substance includes at least one of dimethyl carbonate or ethyl acetate, and based on total mass of the non-aqueous electrolyte, a mass percentage of the first substance is M₁%, where 50≤M₁≤70. The second substance includes at least one of succinonitrile, glutaronitrile, or adiponitrile; and based on the total mass of the non-aqueous electrolyte, a mass percentage of the second substance is M₂%, where 0.01≤M₂≤3.

The non-aqueous electrolyte according to embodiments of the present application includes a specific content of the first substance dimethyl carbonate or ethyl acetate and the second substance dinitrile compound, which has strong electrolyte solubility and low electrolyte viscosity and can improve the cycling life of the battery. On this basis, the inventors have found that dinitrile compounds can be adsorbed on the surface of the positive electrode, and reducing impact of alkaline substances on the surface of the positive electrode material on the α-H of dimethyl carbonate or ethyl acetate in the electrolyte, thereby inhibiting occurrence of side reactions; in addition, the dinitrile compounds can react with the negative electrode current collector to generate insoluble substances, forming a protective layer on the surface of the current collector, reducing self-discharge caused by corrosion of the negative electrode current collector, thereby improving the cycling life of the electrochemical apparatus along with linear carbonates while also mitigating the self-discharge phenomenon.

In some embodiments, the non-aqueous electrolyte satisfies at least one of the following conditions: (1) 55≤M₁≤65; and (2) 0.1≤M₂≤2. Based on the foregoing embodiments, by regulating the mass percentage of the first substance or the second substance in the electrolyte to satisfy the foregoing ranges, the present application can further improve the cycling life of the electrochemical apparatus while also mitigating the self-discharge phenomenon.

In some embodiments, the non-aqueous electrolyte includes ethylene carbonate, and based on the total mass of the non-aqueous electrolyte, the mass percentage of ethylene carbonate is M₃%, where 5≤M₃≤30. Based on the foregoing embodiments, by controlling the content of ethylene carbonate, the present application can on the one hand increase the dissociation of lithium salts and enhance the conductivity of the electrolyte, and on the other hand, ethylene carbonate can be reduced at the negative electrode to form a polymer protective film, reducing interfacial impedance, thereby synergizing with the dinitrile compound to further improve the cycling life of the electrochemical apparatus while also mitigating the self-discharge phenomenon.

In some embodiments, the non-aqueous electrolyte includes a third substance, the third substance including at least one of lithium tetrafluoroborate, lithium bis(oxalate)borate, lithium difluoro(oxalate)borate, sodium tetrafluoroborate, sodium bis(oxalate)borate, sodium difluoro(oxalate)borate, potassium tetrafluoroborate, potassium bis(oxalate)borate, potassium difluoro(oxalate)borate, cesium tetrafluoroborate, cesium bis(oxalate)borate, or cesium difluoro(oxalate)borate; and based on the total mass of the non-aqueous electrolyte, a mass percentage of the third substance is M₄%, where 0.001≤M₄≤0.5. Based on the foregoing embodiments, the non-aqueous electrolyte of the present application further includes a third substance boron-containing lithium salt, where the electron-deficient boron element can combine with lattice oxygen on the surface of the positive electrode material to form a protective layer, weakening oxidation of the α-H of dimethyl carbonate or ethyl acetate by lattice oxygen, inhibiting occurrence of side reactions, and reducing oxidation of the solvent at the positive electrode, thereby further improving the cycling life of the electrochemical apparatus while also mitigating the self-discharge phenomenon.

In some embodiments, the non-aqueous electrolyte includes a compound of formula I:

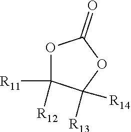

compound of formula I;

where R₁₁, R₁₂, R₁₃, and R¹⁴ are each independently selected from a hydrogen atom, a fluorine atom, a C₁ to C₃ alkyl group, or a fluorine-substituted C₁ to C₃ alkyl group, and at least one of R₁₁, R₁₂, R₁₃, or R₁₄ is a fluorine atom; and based on the total mass of the non-aqueous electrolyte, a mass percentage of the compound of formula I is a %, where 0.01≤a≤1. Based on the foregoing embodiments, the non-aqueous electrolyte of the present application further includes a compound of formula I, which during cycling can generate a protective film on the surface of the negative electrode, inhibiting reduction reactions of components in the electrolyte at the negative electrode surface, reducing increase in negative electrode impedance, and suppressing volume expansion of the electrode plate under high-temperature conditions, thereby improving the cycling life and self-discharge performance of the electrochemical apparatus while also mitigating the swelling phenomenon during high-temperature storage.

In some embodiments, the compound of formula I includes at least one of the following compounds:

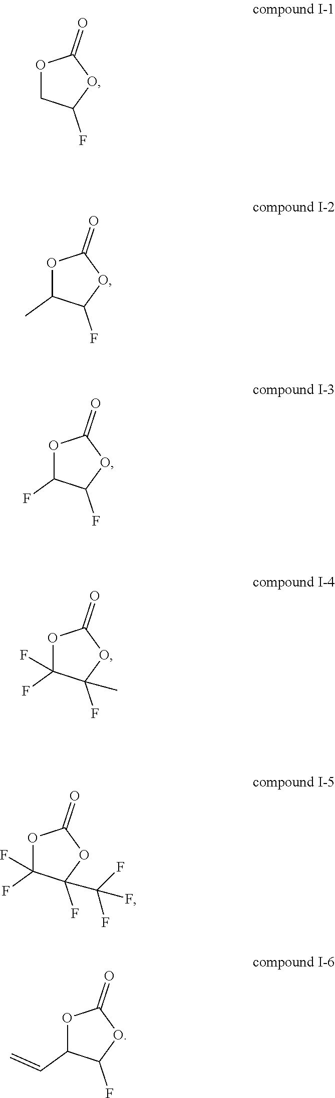

Based on the foregoing embodiments, by selecting the foregoing compound of formula I, the present application can more efficiently generate a protective film on the surface of the negative electrode, inhibiting reduction reactions of components in the electrolyte at the negative electrode surface, reducing increase in negative electrode impedance, and suppressing volume expansion of the electrode plate under high-temperature conditions, thereby further improving the cycling life and self-discharge performance of the electrochemical apparatus while also mitigating the swelling phenomenon during high-temperature storage.

In some embodiments, the non-aqueous electrolyte includes a compound of formula II:

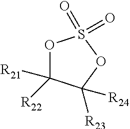

compound of formula II;
where R₂₁, R₂₂, R₂₃, and R₂₄ are each independently selected from at least one of a hydrogen atom, a fluorine atom, or an unsubstituted or fluorine-substituted methyl group, ethyl group, n-propyl group, isopropyl group, vinyl group, or ethynyl group; and
based on the total mass of the non-aqueous electrolyte, a mass percentage of the compound of formula II is b %, where 0.01≤b≤0.3. Based on the foregoing embodiments, by introducing the compound of formula II in the present application, reduction can be implemented at the negative electrode surface to form a protective film containing components such as Li₂SO₄ and Li₂S, which has strong Li⁺ conduction capability and low impedance, thereby improving the cycling life and self-discharge performance of the electrochemical apparatus while also mitigating the swelling phenomenon during high-temperature storage.

In some embodiments, the compound of formula II includes at least one of the following compounds:

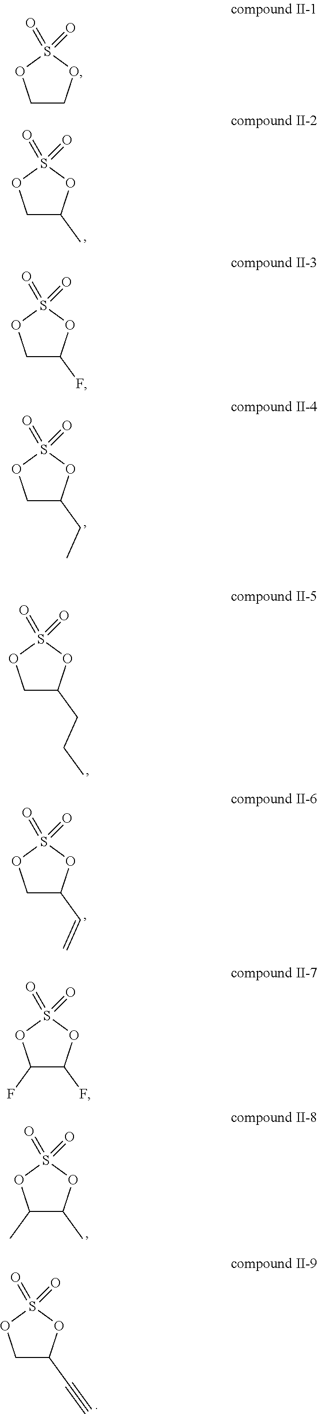

Based on the foregoing embodiments, by selecting the foregoing compound of formula II, the present application can further improve the cycling life and self-discharge performance of the electrochemical apparatus while also mitigating the swelling phenomenon during high-temperature storage.

In some embodiments, the non-aqueous electrolyte includes a compound of formula III:

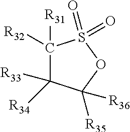

compound of formula III;
where R₃₁, R₃₂, R₃₃, R₃₄, R₃₅, and R₃₆ are each independently selected from a hydrogen atom, a fluorine atom, a C₁ to C₃ alkyl group, or a fluorine-substituted C₁ to C₃ alkyl group; and based on the total mass of the non-aqueous electrolyte, a mass percentage of the compound of formula III is c %, where 0.1≤c≤3. Based on the foregoing embodiments, by introducing the compound of formula III in the present application, an interfacial protective film containing Li₂SO₃ can be formed on the surface of the positive electrode, which on the one hand can reduce occurrence of side reactions and on the other hand has good Lit conduction capability, thereby improving the cycling life and self-discharge performance of the electrochemical apparatus while also mitigating the swelling phenomenon during high-temperature storage.

In some embodiments, the compound of formula III includes at least one of the following compounds:

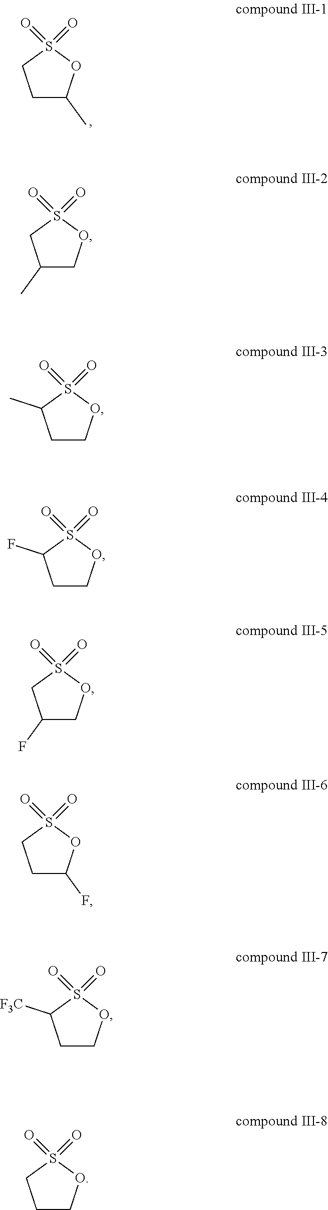

Based on the foregoing embodiments, by selecting the foregoing compound of formula III, the present application can further improve the cycling life and self-discharge performance of the electrochemical apparatus while also mitigating the swelling phenomenon during high-temperature storage.

According to a second aspect, embodiments of the present application provide an electrochemical apparatus, including an electrode assembly and the non-aqueous electrolyte described above; the electrode assembly includes a positive electrode, a separator, and a negative electrode that are sequentially stacked and wound; the positive electrode includes a positive electrode current collector and a positive electrode active material layer provided on at least one surface of the positive electrode current collector, the positive electrode active material layer including nickel element; and based on the total mass of the positive electrode active material layer, a mass percentage of the nickel element is m %, where 30≤m≤56. Based on the foregoing embodiments, the positive electrode active material layer of the electrochemical apparatus of the present application includes the nickel element, the surface of which has alkaline substances that more readily cause dehydrogenation of α-H in electrolyte components, and on this basis, in cooperation with the use of the foregoing non-aqueous electrolyte, the dinitrile compounds in the electrolyte can be adsorbed on the surface of the positive electrode, reducing impact of alkaline substances on the surface of the positive electrode material on the α-H of dimethyl carbonate or ethyl acetate in the electrolyte, and inhibiting occurrence of side reactions, thereby improving the cycling life and self-discharge performance of the electrochemical apparatus while also mitigating the swelling phenomenon during high-temperature storage.

In some embodiments, the positive electrode active material in the positive electrode active material layer includes LiₓNi_{y}M_{1-y}O_{2-z}A_{z}, where 0.9≤x≤1.2, 0.5≤y≤0.85, 0≤z≤0.2. The element M is selected from at least one of aluminum element, magnesium element, manganese element, cobalt element, iron element, chromium element, vanadium element, titanium element, copper element, calcium element, zinc element, zirconium element, niobium element, molybdenum element, strontium element, antimony element, tungsten element, or bismuth element. The element A is selected from at least one of fluorine element, phosphorus element, sulfur element, boron element, silicon element, or chlorine element. Based on the foregoing embodiments, the positive electrode active material layer of the electrochemical apparatus of the present application includes the foregoing active material, which can better cooperate with the electrolyte, thereby improving the cycling life and self-discharge performance of the electrochemical apparatus while also mitigating the swelling phenomenon during high-temperature storage.

In some embodiments, the outermost turn of the electrode assembly has a terminating section; the electrode assembly includes an adhesive tape, the adhesive tape being adhered to the terminating section; and the width of the adhesive tape is W mm, where 10≤W≤25. Based on the foregoing embodiments, by limiting the width of the terminating section adhesive tape to the foregoing range, the electrochemical apparatus of the present application can alleviate the problem of adhesive tape detachment caused by similarity in molecular polarity between dimethyl carbonate or ethyl acetate in the electrolyte and the binder on the adhesive tape, thereby improving the cycling life and self-discharge performance of the electrochemical apparatus while also mitigating the swelling phenomenon during high-temperature storage.

In some embodiments, the adhesive tape includes a substrate and an adhesive layer; and the thickness of the substrate is T μm, where 10≤T≤50. Based on the foregoing embodiments, by limiting the thickness of the substrate to the foregoing range, the present application can reduce the problem of swelling and detachment of the adhesive tape substrate caused by electrolyte seepage, thereby improving the cycling life and self-discharge performance of the electrochemical apparatus while also mitigating the swelling phenomenon during high-temperature storage.

According to a third aspect, embodiments of the present application provide an electronic apparatus including the electrochemical apparatus described above.

### DETAILED DESCRIPTION

To make the objectives, technical solutions, and advantages of the present application clearer, the present application will be further described in detail below in conjunction with embodiments. It should be understood that the specific embodiments described herein are only used to explain the present application and are not intended to limit the present application.

A first aspect of embodiments of the present application provides an electrochemical apparatus including a non-aqueous electrolyte and an electrode assembly, the electrode assembly including a positive electrode, a negative electrode, and a separator that are sequentially stacked and wound.

### Non-Aqueous Electrolyte

The non-aqueous electrolyte used in the electrochemical apparatus of the present application includes an electrolyte salt and a solvent for dissolving the electrolyte salt.

In some embodiments, the non-aqueous electrolyte includes a first substance and a second substance. The first substance includes at least one of dimethyl carbonate or ethyl acetate. Based on total mass of the non-aqueous electrolyte, a mass percentage of the first substance is M₁%, where 50≤M₁≤70, preferably 55≤M₁≤65. For example, the mass percentage of the first substance in the non-aqueous electrolyte may be 50, 51, 55, 58, 62, 65, 69, 70, or any value in a range defined by any two of these values. The second substance includes at least one of succinonitrile, glutaronitrile, or adiponitrile. Based on the total mass of the non-aqueous electrolyte, the mass percentage of the second substance is M₂%, where 0.01≤M₂≤3, preferably 0.1≤M₂≤2. For example, the mass percentage of the second substance in the non-aqueous electrolyte may be 0.01, 0.1, 0.16, 0.50, 0.70, 1.00, 1.27, 1.81, 2, 2.45, 2.71, 3, or any value in a range defined by any two of these values. The non-aqueous electrolyte including a specific content of dimethyl carbonate or ethyl acetate and a dinitrile compound can improve the cycling life of the electrochemical apparatus while also mitigating the self-discharge phenomenon.

In some embodiments, the non-aqueous electrolyte includes ethylene carbonate, and based on the total mass of the non-aqueous electrolyte, the mass percentage of ethylene carbonate is M₃%, where 5≤M₃≤30. For example, the mass percentage of ethylene carbonate in the non-aqueous electrolyte may be 5, 9, 11, 17, 18, 25, 27, 30, or any value in a range defined by any two of these values. The non-aqueous electrolyte further including a specific content of ethylene carbonate can further improve the cycling life of the electrochemical apparatus while also mitigating the self-discharge phenomenon.

In some embodiments, the non-aqueous electrolyte includes a third substance, the third substance including at least one of lithium tetrafluoroborate, lithium bis(oxalate)borate, lithium difluoro(oxalate)borate, sodium tetrafluoroborate, sodium bis(oxalate)borate, sodium difluoro(oxalate)borate, potassium tetrafluoroborate, potassium bis(oxalate)borate, potassium difluoro(oxalate)borate, cesium tetrafluoroborate, cesium bis(oxalate)borate, or cesium difluoro(oxalate)borate. Based on the total mass of the non-aqueous electrolyte, a mass percentage of the third substance is M₄%, where 0.001≤M₄≤0.5. For example, the mass percentage of the third substance in the non-aqueous electrolyte may be 0.001, 0.067, 0.130, 0.210, 0.280, 0.407, 0.463, 0.5, or any value in a range defined by any two of these values. The non-aqueous electrolyte further including a specific content of a boron-containing lithium salt can further improve the cycling life of the electrochemical apparatus while also mitigating the self-discharge phenomenon.

In some embodiments, the non-aqueous electrolyte includes a compound of formula I:

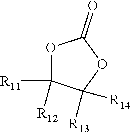

compound of formula I;
where R₁₁, R₁₂, R₁₃, and R₁₄ are each independently selected from a hydrogen atom, a fluorine atom, a C₁ to C₃ alkyl group, or a fluorine-substituted C₁ to C₃ alkyl group, and at least one of R₁₁, R₁₂, R₁₃, or R₁₄ is a fluorine atom. Based on the total mass of the non-aqueous electrolyte, a mass percentage of the compound of formula I is a %, where 0.01≤a≤1. For example, the mass percentage of the compound of formula I in the non-aqueous electrolyte may be 0.01, 0.06, 0.27, 0.47, 0.66, 0.88, 1, or any value in a range defined by any two of these values. The non-aqueous electrolyte further including a specific content of the compound of formula I, which during cycling can generate a protective film on the surface of the negative electrode, can further improve the cycling life and self-discharge performance of the electrochemical apparatus while also mitigating the swelling phenomenon during high-temperature storage.

In some embodiments, the compound of formula I includes at least one of the following compounds:

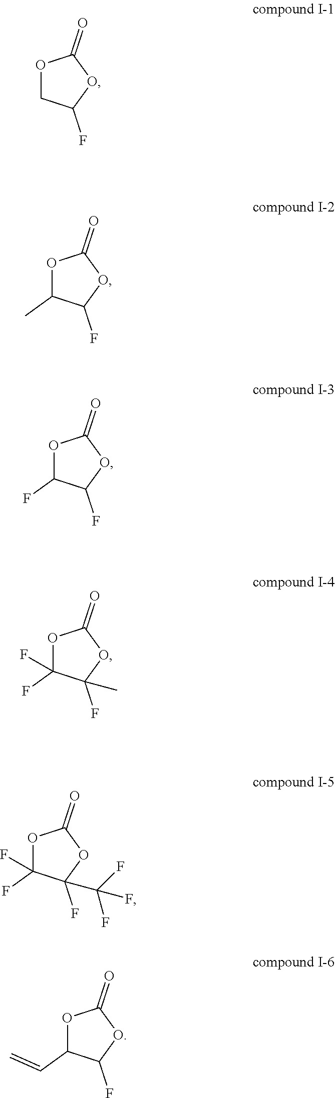

By selecting the foregoing compound of formula I, a protective film can be more efficiently generated on the surface of the negative electrode, thereby further improving the cycling life and self-discharge performance of the electrochemical apparatus while also mitigating the swelling phenomenon during high-temperature storage.

In some embodiments, the non-aqueous electrolyte includes a compound of formula II:

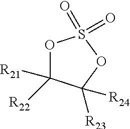

compound of formula II;

where R₂₁, R₂₂, R₂₃, and R₂₄ are each independently selected from at least one of a hydrogen atom, a fluorine atom, or an unsubstituted or fluorine-substituted methyl group, ethyl group, n-propyl group, isopropyl group, vinyl group, or ethynyl group; and based on the total mass of the non-aqueous electrolyte, a mass percentage of the compound of formula II is b %, where 0.01≤b≤0.3. For example, the mass percentage of the compound of formula II in the non-aqueous electrolyte may be 0.01, 0.04, 0.10, 0.11, 0.17, 0.22, 0.3, or any value in a range defined by any two of these values. The non-aqueous electrolyte further including a specific content of the compound of formula II can further improve the cycling life and self-discharge performance of the electrochemical apparatus while also mitigating the swelling phenomenon during high-temperature storage.

In some embodiments, the compound of formula II includes at least one of the following compounds:

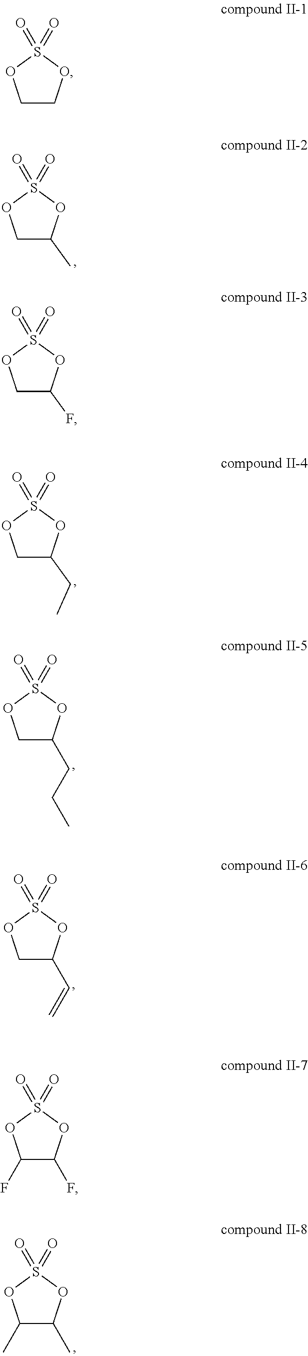

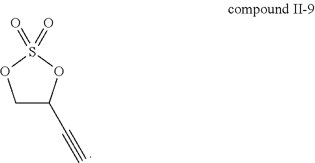

By selecting the foregoing compound of formula II, the cycling life and self-discharge performance of the electrochemical apparatus can be further improved, and the swelling phenomenon during high-temperature storage is also reduced.

In some embodiments, the non-aqueous electrolyte includes a compound of formula. III:

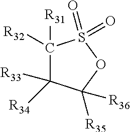

compound of formula III;
where R₃₁, R₃₂, R₃₃, R₃₄, R₃₅, and R₃₆ are each independently selected from a hydrogen atom, a fluorine atom, a C₁ to C₃ alkyl group, or a fluorine-substituted C₁ to C₃ alkyl group; and based on the total mass of the non-aqueous electrolyte, a mass percentage of the compound of formula III is c %, where 0.1≤c≤3. For example, the mass percentage of the compound of formula III in the non-aqueous electrolyte may be 0.1, 0.2, 0.6, 1.3, 1.9, 2.3, 2.5, 3, or any value in a range defined by any two of these values. The non-aqueous electrolyte further including a specific content of the compound of formula III can further improve the cycling life and self-discharge performance of the electrochemical apparatus while also mitigating the swelling phenomenon during high-temperature storage.

In some embodiments, the compound of formula III includes at least one of the following compounds:

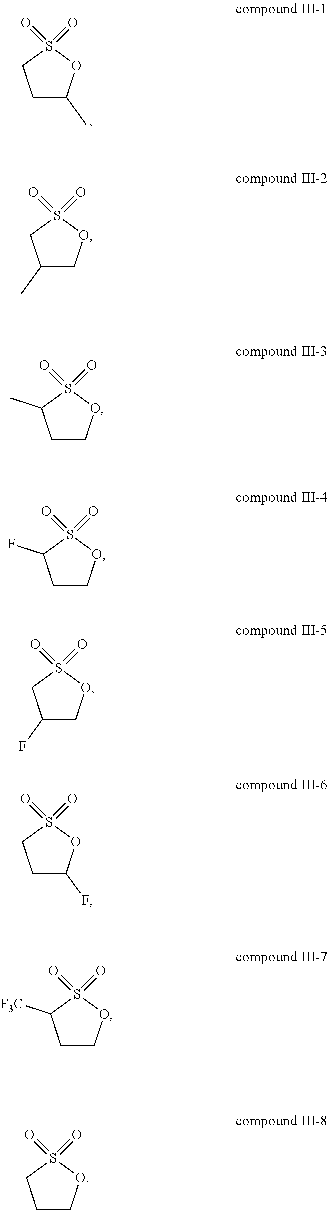

By selecting the foregoing compound of formula III, the cycling life and self-discharge performance of the electrochemical apparatus can be further improved, and the swelling phenomenon during high-temperature storage is also mitigated.

In some embodiments, the lithium salt in the non-aqueous electrolyte of the present application may further include, but is not limited to, at least one of lithium hexafluorophosphate (LiPF₆), lithium difluorophosphate (LiPO₂F₂), lithium bis(trifluoromethanesulfonyl)imide (LiTFSI), or lithium bis(fluorosulfonyl)imide (LiFSI). Based on the mass of the non-aqueous electrolyte, the mass percentage of the lithium salt may be 8% to 13%, for example, the mass percentage of the lithium salt may be 8%, 9%, 10%, 11%, 12.5%, 13%, or a range defined by any two of these values.

The present application imposes no particular restriction on the types of other non-aqueous solvents, provided that the objective of the present application can be achieved. For example, they may include, but are not limited to, at least one of other carbonate compounds, other carboxylate compounds, ether compounds, or other organic solvents. For example, the other carbonate compounds may include, but are not limited to, at least one of diethyl carbonate, dipropyl carbonate, methyl propyl carbonate, ethyl propyl carbonate, methyl ethyl carbonate, propylene carbonate, butylene carbonate, or ethylene vinyl carbonate. For example, the other carboxylate compounds may include, but are not limited to, at least one of methyl formate, methyl acetate, n-propyl acetate, tert-butyl acetate, methyl propionate, ethyl propionate, propyl propionate, γ-butyrolactone, decanolactone, valerolactone, or caprolactone. For example, the ether compounds may include, but are not limited to, at least one of ethylene glycol dimethyl ether, dibutyl ether, tetraethylene glycol dimethyl ether, diethylene glycol dimethyl ether, 1,2-dimethoxyethane, 1,2-diethoxyethane, 1-ethoxy-1-methoxyethane, 2-methyltetrahydrofuran, or tetrahydrofuran. For example, the other organic solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

### Positive Electrode

The positive electrode includes a positive electrode current collector and a positive electrode active material layer provided on at least one surface of the positive electrode current collector.

In some embodiments, the positive electrode active material layer includes nickel element. Based on the total mass of the positive electrode active material layer, a mass percentage of the nickel element is m %, where 30≤m≤56. For example, the mass percentage of the nickel element in the positive electrode active material layer may be 30, 37, 41, 46, 48, 53, 56, or any value in a range defined by any two of these values. The positive electrode active material layer including the nickel element, when used in cooperation with the foregoing non-aqueous electrolyte system, can improve the cycling life and self-discharge performance of the electrochemical apparatus while also mitigating the swelling phenomenon during high-temperature storage.

In some embodiments, the positive electrode active material in the positive electrode active material layer includes LiₓNi_{y}M_{1-y}O_{2-z}A_{z}, where 0.9≤x≤1.2, 0.5≤y≤0.85, 0≤z≤0.2. For example, the value of x may be 0.9, 1.0, 1.1, 1.2, or any value in a range defined by any two of these values. For example, the value of y may be 0.5, 0.6, 0.7, 0.8, 0.85, or any value in a range defined by any two of these values. For example, the value of z may be 0, 0.1, 0.2, or any value in a range defined by any two of these values. The element M is selected from at least one of aluminum element, magnesium element, manganese element, cobalt element, iron element, chromium element, vanadium element, titanium element, copper element, calcium element, zinc element, zirconium element, niobium element, molybdenum element, strontium element, antimony element, tungsten element, or bismuth element. The element A is selected from at least one of fluorine element, phosphorus element, sulfur element, boron element, silicon element, or chlorine element. The positive electrode active material layer including the foregoing active material can better cooperate with the electrolyte, thereby improving the cycling life and self-discharge performance of the electrochemical apparatus while also mitigating the swelling phenomenon during high-temperature storage.

In some embodiments, the positive electrode material layer includes a positive electrode conductive material. There is no restriction on the type of positive electrode conductive material, and any known conductive material may be used. Examples of positive electrode conductive materials may include, but are not limited to, carbon black such as acetylene black and Super-P; amorphous carbon such as needle coke; carbon nanotubes; graphene; and the like. The foregoing positive electrode conductive materials may be used alone or in any combination.

In some embodiments, the positive electrode material layer includes a positive electrode binder; there is no particular restriction on the type of positive electrode binder, and in the case of a coating method, any material that is soluble or dispersible in the liquid medium used during electrode manufacture may be used. Examples of positive electrode binders may include, but are not limited to, one or more of the following: resin polymers such as polyethylene, polypropylene, polyethylene terephthalate, polymethyl methacrylate, polyimide, aromatic polyamide, cellulose, and nitrocellulose; rubber-like polymers such as styrene-butadiene rubber, nitrile rubber, fluororubber, isoprene rubber, polybutadiene rubber, and ethylene-propylene rubber; thermoplastic elastomer-like polymers such as styrene-butadiene-styrene block copolymers or hydrogenated products thereof, ethylene-propylene-diene terpolymers, styrene-ethylene-butadiene-ethylene copolymers, styrene-isoprene-styrene block copolymers or hydrogenated products thereof; soft resin-like polymers such as syndiotactic-1,2-polybutadiene, polyvinyl acetate, ethylene-vinyl acetate copolymers, and propylene-α-olefin copolymers; fluorine-based polymers such as polyvinylidene fluoride, polytetrafluoroethylene, fluorinated polyvinylidene fluoride, and polytetrafluoroethylene-ethylene copolymers; and polymer compositions having ionic conductivity for alkali metal ions; and the like. The foregoing positive electrode binders may be used alone or in any combination.

There is no restriction on the type of solvent used to form a positive electrode slurry, provided that it is capable of dissolving or dispersing the positive electrode active material, conductive material, positive electrode binder, and optionally used thickener. Examples of solvents used to form the positive electrode slurry may include either aqueous solvents or organic solvents. Examples of aqueous media may include, but are not limited to, mixed media of alcohol and water, or water, or the like. Examples of organic media may include, but are not limited to, aliphatic hydrocarbons such as hexane; aromatic hydrocarbons such as benzene, toluene, xylene, and methylnaphthalene; heterocyclic compounds such as quinoline and pyridine; ketones such as acetone, methyl ethyl ketone, and cyclohexanone; esters such as methyl acetate and methyl acrylate; amines such as diethylenetriamine and N,N-dimethylaminopropylamine; ethers such as diethyl ether, propylene oxide, and tetrahydrofuran; amides such as N-methylpyrrolidone, dimethylformamide, and dimethylacetamide; aprotic polar solvents such as hexamethylphosphoramide and dimethyl sulfoxide; and the like.

Thickeners are generally used to adjust the viscosity of the slurry. In the case of using an aqueous medium, a thickener and a styrene-butadiene rubber emulsion may be used for slurrying. There is no particular restriction on the type of thickener, and examples may include, but are not limited to, carboxymethyl cellulose, methyl cellulose, hydroxymethyl cellulose, ethyl cellulose, polyvinyl alcohol, oxidized starch, phosphorylated starch, casein, salts thereof, and the like. The foregoing thickeners may be used alone or in any combination.

There is no particular restriction on the type of positive electrode current collector, and any material known to be suitable for use as a positive electrode current collector may be used. Examples of positive electrode current collectors may include, but are not limited to, metal materials such as aluminum, stainless steel, nickel plating, titanium, and tantalum; and materials such as carbon cloth and carbon paper. In some embodiments, the positive electrode current collector is a metal material. In some embodiments, the positive electrode current collector is aluminum.

To reduce the electronic contact resistance between the positive electrode current collector and the positive electrode material layer, the surface of the positive electrode current collector may include a conductive aid or a conductive coating. Examples of conductive aids may include, but are not limited to, carbon and noble metals such as gold, platinum, and silver. Examples of conductive coatings may include mixed material layers containing inorganic oxides, conductive agents, and binders.

### Negative Electrode

The negative electrode includes a negative electrode current collector and a negative electrode material layer provided on at least one surface of the negative electrode current collector, the negative electrode material layer including a negative electrode active material. In some embodiments, the rechargeable capacity of the negative electrode active material is greater than the discharge capacity of the positive electrode active material to prevent unintentional precipitation of lithium metal on the negative electrode during charging.

In some embodiments, the negative electrode active material may include at least one of natural graphite, artificial graphite, mesocarbon microbeads (MCMB), silicon, silicon-carbon composite, SiO_{w} (0.5<w<1.6), Li—Sn alloy, Li—Sn—O alloy, Sn, SnO, SnO₂, spinel-structured lithiated titanate Li₄Ti₅O₁₂, Li—Al alloy, or metallic lithium. Optionally, the negative electrode active material may further include an amorphous carbon material, and the amorphous carbon may be soft carbon (low-temperature calcined carbon), hard carbon, mesophase pitch carbide, calcined coke, or the like.

The negative electrode material layer of the present application further includes a negative electrode binder. The negative electrode binder can improve the binding between negative electrode active material particles and the binding between the negative electrode active material and the current collector. There is no particular restriction on the type of negative electrode binder, provided that it is a material stable to the non-aqueous electrolyte or the solvent used during electrode manufacture. In some embodiments, the negative electrode binder includes a resin binder. Examples of resin binders include, but are not limited to, fluororesins, polyacrylonitrile (PAN), polyimide resins, acrylic resins, polyolefin resins, and the like. When an aqueous solvent is used to prepare the negative electrode mixture slurry, the negative electrode binder includes, but is not limited to, carboxymethyl cellulose (CMC) or salts thereof, styrene-butadiene rubber (SBR), polyacrylic acid (PAA) or salts thereof, polyvinyl alcohol, and the like.

The negative electrode material layer of the present application further includes a conductive agent. There is no particular restriction on the type of negative electrode conductive agent in the present application, provided that the objective of the present application can be achieved. For example, the negative electrode conductive agent may be at least one of acetylene black, Ketjen black, carbon nanotubes, carbon fibers, carbon dots, or graphene, and the foregoing carbon nanotubes may include, but are not limited to, at least one of single-walled carbon nanotubes or multi-walled carbon nanotubes.

There is no particular restriction on the negative electrode current collector in the present application, provided that the objective of the present application can be achieved. For example, the negative electrode current collector may include copper foil, aluminum foil, nickel foil, stainless steel foil, titanium foil, nickel foam, copper foam, a polymer substrate coated with a conductive metal, or the like. The conductive metal includes, but is not limited to, copper, nickel, or titanium, and the material of the polymer substrate includes, but is not limited to, at least one of polyethylene, polypropylene, ethylene-propylene copolymer, polyethylene terephthalate, polyethylene naphthalate, or poly(p-phenylene terephthalamide). In the present application, there is no particular restriction on the thickness of the negative electrode current collector and the negative electrode material layer, provided that the objective of the present application can be achieved. For example, the thickness of the negative electrode current collector is 4 μm to 12 μm, and the thickness of the single-sided negative electrode material layer is 30 μm to 160 μm. In the present application, the negative electrode mixture layer may be provided on one surface in the thickness direction of the negative electrode current collector or on both surfaces in the thickness direction of the negative electrode current collector. It should be noted that the “surface” here may be the entire area of the negative electrode current collector or a part of the area of the negative electrode current collector, and the present application imposes no particular restriction, provided that the objective of the present application can be achieved.

There is no particular restriction on the compaction density of the negative electrode plate in the present application, provided that the objective of the present application can be achieved. For example, the compaction density of the negative electrode plate may be 1.0 g/cm³ to 1.85 g/cm³. There is no particular restriction on the cold pressing pressure of the negative electrode plate in the present application, provided that the objective of the present application can be achieved. For example, the cold pressing pressure of the negative electrode plate may be 3 tons to 30 tons.

Optionally, the negative electrode plate may further include a conductive layer, the conductive layer being located between the negative electrode current collector and the negative electrode material layer. There is no particular restriction on the composition of the conductive layer in the present application, and it may be a conductive layer commonly used in the art. The conductive layer includes a conductive agent and a binder. There is no particular restriction on the conductive agent and the binder in the conductive layer in the present application, and they may be at least one of the foregoing conductive agents and the foregoing binders. There is no particular restriction on the mass ratio of the conductive agent to the binder in the conductive layer in the present application, and those skilled in the art may select according to actual needs, provided that the objective of the present application can be achieved. There is no particular restriction on the thickness of the conductive layer in the present application, provided that the objective of the present application can be achieved, for example, the thickness of the conductive layer is 1 μm to 10 μm.

### Separator

In the present application, a separator is generally provided between the positive electrode and the negative electrode, the separator being used to separate the positive electrode plate and the negative electrode plate, prevent internal short circuits in the electrochemical apparatus, allow electrolyte ions to pass freely, and not affect the electrochemical charge-discharge process.

There is no particular restriction on the separator in the present application, provided that the objective of the present application can be achieved. For example, the material of the separator may include, but is not limited to, at least one of polyolefins (PO) mainly including polyethylene (PE) and polypropylene (PP), polyester (for example, polyethylene terephthalate (PET) film), cellulose, polyimide (PI), polyamide (PA), spandex, or aramid; and the type of separator may include at least one of woven film, non-woven film, microporous film, composite film, calendered film, or spun film.

In the present application, the separator may include a substrate and a surface treatment layer. The substrate may be a non-woven fabric or composite film having a porous structure, and the material of the substrate may include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used. Optionally, a surface treatment layer is provided on at least one surface of the substrate, and the surface treatment layer may be a polymer layer or an inorganic material layer, or a layer formed by mixing a polymer and an inorganic material. For example, the inorganic material layer includes inorganic particles and a binder, and there is no particular restriction on the foregoing inorganic particles in the present application, for example, they may include at least one of aluminum oxide, silicon oxide, magnesium oxide, titanium oxide, hafnium oxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, and barium sulfate. There is no particular restriction on the foregoing binder in the present application, for example, it may be at least one of the afore-mentioned binders. The polymer layer contains a polymer, and the material of the polymer includes at least one of polyamide, polyacrylonitrile, acrylate polymer, polyacrylic acid, polyvinylpyrrolidone, polyvinyl ether, polyvinylidene fluoride, or poly(vinylidene fluoride-hexafluoropropylene).

In the present application, the pore diameter of the separator is 0.01 μm to 1 μm, and the thickness is 5 μm to 50 μm. In some embodiments, the thickness of the separator is greater than 1 μm, greater than 5 μm, or greater than 8 μm. In some embodiments, the thickness of the separator is less than 50 μm, less than 40 μm, or less than 30 μm. When the thickness of the separator is within the foregoing range, insulation and mechanical strength can be ensured, and the rate performance and energy density of the electrochemical apparatus can be ensured.

The outermost turn of the electrode assembly of embodiments of the present application has a terminating section, the electrode assembly includes an adhesive tape, the adhesive tape being adhered to the terminating section, and the width of the adhesive tape is W mm, where 10≤W≤25. For example, the value of the width of the adhesive tape may be 10, 13, 14, 17, 20, 22, 25, or any value in a range defined by any two of these values. Limiting the width of the terminating section adhesive tape to the foregoing range can improve the cycling life and self-discharge performance of the electrochemical apparatus while also mitigating the swelling phenomenon during high-temperature storage.

In some embodiments, the adhesive tape includes a substrate and an adhesive layer. The thickness of the substrate is T μm, where 10≤T≤50. For example, the value of the thickness of the substrate may be 10, 15, 17, 22, 34, 46, 50, or any value in a range defined by any two of these values. Limiting the thickness of the substrate to the foregoing range can improve the cycling life and self-discharge performance of the electrochemical apparatus while also mitigating the swelling phenomenon during high-temperature storage.

Embodiments of the present application further provide an electronic apparatus including the electrochemical apparatus of embodiments of the present application. The electronic apparatus includes, but is not limited to, notebook computers, pen-input computers, mobile computers, e-book players, portable telephones, portable fax machines, portable copiers, portable printers, stereo headphones, video recorders, LCD televisions, portable cleaners, portable CD players, mini discs, transceivers, electronic organizers, calculators, memory cards, portable recorders, radios, backup power supplies, motors, automobiles, motorcycles, power-assisted bicycles, bicycles, lighting fixtures, toys, game consoles, clocks, power tools, flashlights, cameras, large household batteries, lithium-ion capacitors, and the like.

### EXAMPLES

Hereinafter, taking lithium-ion batteries as an example, examples and comparative examples are provided to more specifically illustrate the implementations of the electrochemical apparatus of the present application. Those skilled in the art will understand that the preparation methods described in the present application are only examples, and any other suitable preparation methods are within the scope of the present application. Various tests and evaluations were performed according to the following methods. In addition, unless otherwise specified, “parts” and “%” are on a mass basis.

### Example 1-1

### (1) Preparation of Positive Electrode

The positive electrode active material LiNi_{0.83}Co_{0.08}Mn_{0.07}Al_{0.02}O₂, conductive agent conductive carbon black, and polyvinylidene fluoride (PVDF) were mixed in a mass ratio of 95:2:3, N-methylpyrrolidone (NMP) was added, and the mixture was uniformly stirred under the action of a vacuum mixer to obtain a positive electrode slurry with a solid content of 70 wt %; the positive electrode slurry was uniformly applied on one surface of a positive electrode current collector aluminum foil with a thickness of 9 μm, dried to obtain a positive electrode plate with a single-sided coated positive electrode mixture layer, with a single-sided coating weight of 12.0 mg/cm². The foregoing steps were repeated on the other surface of the positive electrode current collector aluminum foil to obtain a positive electrode plate with double-sided coated positive electrode mixture layers. After cold pressing, slitting, and welding tabs, drying was performed to obtain a positive electrode plate with a dimension of 74 mm×867 mm.

(2) Preparation of non-aqueous electrolyte: In a dry argon atmosphere glove box, lithium hexafluorophosphate (LiPF₆) was dissolved in a mixed solution of ethyl acetate and succinonitrile to obtain a non-aqueous electrolyte. Based on the total mass of the non-aqueous electrolyte, a mass percentage of LiPF₆ was 12.5%, with the rest being propyl acetate.

(3) Preparation of negative electrode: Using artificial graphite as the negative electrode active material, the negative electrode active material, styrene-butadiene rubber (SBR), polyacrylic acid (PAA), carbon nanotubes (CNT), and carboxymethyl cellulose (CMC) were mixed in a mass ratio of 95.8:2.4:0.5:0.5:0.8, then deionized water was added as a solvent and stirred uniformly to prepare a negative electrode slurry with a solid content of 45 wt %. The negative electrode slurry was uniformly applied on one surface of a negative electrode current collector copper foil with a thickness of 6 μm, dried to obtain a negative electrode plate with a single-sided coated negative electrode mixture layer, with a single-sided coating weight of 7.0 mg/cm². The foregoing steps were repeated on the other surface of the negative electrode current collector copper foil to obtain a negative electrode plate with double-sided coated negative electrode mixture layers. After cold pressing, slitting, and welding tabs, drying was performed to obtain a negative electrode plate with a dimension of 76.6 mm×875 mm.

(4) Preparation of separator: A porous polyethylene film with a thickness of 15 μm was used as the separator.

(5) Preparation of lithium-ion battery: The positive electrode plate, the negative electrode plate, and the separator were stacked in order, with the separator positioned between the positive electrode plate and the negative electrode plate to provide isolation, and were wound to obtain an electrode assembly, and then adhesive tape was attached to the outermost turn of the electrode assembly winding layer to fix the winding structure. The width of the adhesive tape was 10 mm, and the thickness of the adhesive tape substrate was 10 μm. The electrode assembly was placed in a packaging pouch, the non-aqueous electrolyte was injected, and encapsulation was performed. After standing, formation, degassing, edge cutting, capacity testing, and other processes, a lithium-ion battery was obtained.

### <Test Methods>

### Cycling Life Test

A lithium-ion battery was placed in a 45° C. high-temperature oven and left standing for 60 min to reach a constant temperature. After the battery reached a constant temperature, it was charged at a constant current of 1 C to 4.25 V, then charged at a constant voltage of 4.25 V until the current was 0.05 C, left standing for 15 min, then discharged at 1 C to 2.8 V, and left standing for 15 min, and the discharge capacity of this step was recorded as C₁. The foregoing charging and discharging process was repeated 1000 times, and the discharge capacity of the 1000th cycle was recorded as C₂.

Cycling life retention rate %=(C₁-C₂)/C₁×100%.

### Self-Discharge Performance Test

A lithium-ion battery was charged at a constant current of 0.5 C at 25° C. to 4.25 V, then charged at constant current and constant voltage under this charging condition until the current was less than or equal to 0.05 C, and left standing for 15 min; then discharged at a constant current of 0.5 C to 2.8 V, and left standing for 15 min; then charged at a constant current of 0.5 C for 30 min, the voltage at the end of charging was recorded as V₀, then left standing for 48 h, and the voltage at this time was recorded as V₁.

Self-discharge coefficient=(V₀−V₁)/48.

### High-Temperature Storage Thickness Change Rate Test

A lithium-ion battery was charged at a constant current of 0.5 C at 25° C. to 4.25 V, then charged at a constant voltage of 4.25 V until the current was less than or equal to 0.05 C, and then left standing for 15 minutes, and the thickness at this time was measured as h₀; then the lithium-ion battery was placed in an 85° C. high-temperature chamber and stored for 24 h, and taken out, and the thickness of the cell was tested within 5 minutes after removal as h₁.

High-temperature storage thickness change rate %=(h₁−h₀)/h₀×100%.

The lithium-ion batteries of the following examples or comparative examples differ from Example 1-1 only in that the types and mass percentages of the components in the non-aqueous electrolyte were adjusted according to Table 1. The performance test results of the lithium-ion batteries of the examples and comparative examples are shown in Table 1 below.

TABLE 1

| | | | | | | | | Cycling | Self- |
|---|---|---|---|---|---|---|---|---|---|
| | | | | | | | | capacity | discharge |
| | First | | Second | M₂ | M₃ | | | retention | coefficient |
| Group | substance | M₁ (%) | substance | (%) | (%) | Third substance | M₄ (%) | rate (%) | (mV/h) |
| Example 1-1 | Ethyl | 50 | Succinonitrile | 2 | 10 | / | 0 | 81.40 | 0.038 |
| | acetate | | | | | | | | |
| Example 1-2 | Dimethyl | 50 | Succinonitrile | 2 | 10 | / | 0 | 80.80 | 0.032 |
| | carbonate | | | | | | | | |
| Example 1-3 | Dimethyl | 55 | Succinonitrile | 2 | 10 | / | 0 | 83.20 | 0.028 |
| | carbonate | | | | | | | | |
| Example 1-4 | Dimethyl | 60 | Succinonitrile | 2 | 10 | / | 0 | 83.90 | 0.024 |
| | carbonate | | | | | | | | |
| Example 1-5 | Dimethyl | 65 | Succinonitrile | 2 | 10 | / | 0 | 84.10 | 0.022 |
| | carbonate | | | | | | | | |
| Example 1-6 | Dimethyl | 70 | Succinonitrile | 2 | 10 | / | 0 | 82.50 | 0.3 |
| | carbonate | | | | | | | | |
| Example 1-7 | Dimethyl | 55 | Glutaronitrile | 2 | 10 | / | 0 | 83.30 | 0.027 |
| | carbonate | | | | | | | | |
| Example 1-8 | Dimethyl | 55 | Adiponitrile | 2 | 10 | / | 0 | 83.00 | 0.025 |
| | carbonate | | | | | | | | |
| Example 1-9 | Dimethyl | 55 | Succinonitrile | 0.01 | 10 | / | 0 | 81.50 | 0.043 |
| | carbonate | | | | | | | | |
| Example 1- | Dimethyl | 55 | Succinonitrile | 0.1 | 10 | / | 0 | 81.90 | 0.04 |
| 10 | carbonate | | | | | | | | |
| Example 1- | Dimethyl | 55 | Succinonitrile | 0.5 | 10 | / | 0 | 82.40 | 0.037 |
| 11 | carbonate | | | | | | | | |
| Example 1- | Dimethyl | 55 | Succinonitrile | 1 | 10 | / | 0 | 82.70 | 0.035 |
| 12 | carbonate | | | | | | | | |
| Example 1- | Dimethyl | 55 | Succinonitrile | 3 | 10 | / | 0 | 81.80 | 0.036 |
| 13 | carbonate | | | | | | | | |
| Example 1- | Dimethyl | 55 | Succinonitrile | 2 | 5 | / | 0 | 82.20 | 0.029 |
| 14 | carbonate | | | | | | | | |
| Example 1- | Dimethyl | 55 | Succinonitrile | 2 | 15 | / | 0 | 83.70 | 0.027 |
| 15 | carbonate | | | | | | | | |
| Example 1- | Dimethyl | 55 | Succinonitrile | 2 | 30 | / | 0 | 82.80 | 0.025 |
| 16 | carbonate | | | | | | | | |
| Example 1- | Dimethyl | 55 | Succinonitrile | 2 | 10 | Lithium | 0.001 | 84.70 | 0.026 |
| 17 | carbonate | | | | | tetrafluoroborate | | | |
| Example 1- | Dimethyl | 55 | Succinonitrile | 2 | 10 | Sodium | 0.001 | 84.50 | 0.026 |
| 18 | carbonate | | | | | bis(oxalate)borate | | | |
| Example 1- | Dimethyl | 55 | Succinonitrile | 2 | 10 | Lithium | 0.001 | 84.90 | 0.025 |
| 19 | carbonate | | | | | difluoro(oxalate)borate | | | |
| Example 1- | Dimethyl | 55 | Succinonitrile | 2 | 10 | Lithium | 0.06 | 85.40 | 0.024 |
| 20 | carbonate | | | | | difluoro(oxalate)borate | | | |
| Example 1- | Dimethyl | 55 | Succinonitrile | 2 | 10 | Lithium | 0.2 | 85.90 | 0.023 |
| 21 | carbonate | | | | | difluoro(oxalate)borate | | | |
| Example 1- | Dimethyl | 55 | Succinonitrile | 2 | 10 | Lithium | 0.4 | 86.10 | 0.022 |
| 22 | carbonate | | | | | difluoro(oxalate)borate | | | |
| Example 1- | Dimethyl | 55 | Succinonitrile | 2 | 10 | Lithium | 0.5 | 85.80 | 0.024 |
| 23 | carbonate | | | | | difluoro(oxalate)borate | | | |
| Example 1- | Dimethyl | 60 | Succinonitrile + | 0.2 + | 15 | Potassium | 0.25 | 86.50 | 0.022 |
| 24 | carbonate | | glutaronitrile | 0.5 | | tetrafluoroborate | | | |
| Example 1- | Dimethyl | 47 + | Glutaronitrile + | 0.2 + | 15 | Lithium | 0.3 | 86.80 | 0.021 |
| 25 | carbonate + | 13 | adiponitrile | 0.4 | | bis(oxalate)borate | | | |
| | ethyl acetate | | | | | | | | |
| Comparative | Dimethyl | 45 | Succinonitrile | 2 | 10 | / | 0 | 71.20 | 0.053 |
| Example 1 | carbonate | | | | | | | | |
| Comparative | Dimethyl | 72 | Succinonitrile | 2 | 10 | / | 0 | 70.50 | 0.058 |
| Example 2 | carbonate | | | | | | | | |
| Comparative | Dimethyl | 50 | Succinonitrile | 0.005 | 10 | / | 0 | 71.40 | 0.06 |
| Example 3 | carbonate | | | | | | | | |
| Comparative | Dimethyl | 50 | Succinonitrile | 3.5 | 10 | / | 0 | 71.80 | 0.05 |
| Example 4 | carbonate | | | | | | | | |

*For the positive electrode parameters and parameters of other components for the examples in the foregoing table, refer to those for Example 1-25 in Table 2.

As can be seen from Table 1, for the lithium-ion batteries prepared in the examples of the present application, when the non-aqueous electrolyte includes the first substance dimethyl carbonate or ethyl acetate and the second substance succinonitrile, glutaronitrile, or adiponitrile, and the mass percentages of the first substance and the second substance respectively satisfy 50≤M₁≤70 and 0.01≤M₂≤3, the lithium-ion batteries have superior cycling capacity retention rate and lower self-discharge level. In particular, for the lithium-ion batteries prepared in the examples of the present application, when the mass percentage of the first substance in the non-aqueous electrolyte further satisfies 55≤M₁≤65, the lithium-ion batteries have even superior cycling capacity retention rate and lower self-discharge level. In particular, for the lithium-ion batteries prepared in the examples of the present application, when the mass percentage of the second substance in the non-aqueous electrolyte further satisfies 0.1≤M₂≤2, the lithium-ion batteries have even superior cycling capacity retention rate and lower self-discharge level. In particular, for the lithium-ion batteries prepared in the examples of the present application, when the non-aqueous electrolyte further includes ethylene carbonate and its mass percentage satisfies 5≤M₃≤30, the lithium-ion batteries have even superior cycling capacity retention rate and lower self-discharge level. In particular, for the lithium-ion batteries prepared in the examples of the present application, when the non-aqueous electrolyte further includes a third substance and its mass percentage satisfies 0.001≤M₄≤0.5, the lithium-ion batteries have even superior cycling capacity retention rate and lower self-discharge level.

The lithium-ion batteries in the following examples 2-1 to 2-31 differ from example 1-25 only in that the types and mass percentages of the components in the non-aqueous electrolyte, the mass percentage of nickel element in the positive electrode active material layer, the adhesive tape width, and the adhesive tape substrate thickness parameters were adjusted according to Table 2.

TABLE 2

| | | | | | | | | | | | | High- |
|---|---|---|---|---|---|---|---|---|---|---|---|---|
| | | | | | | | | | | | | temperature |
| | | | | | | | | | | Cycling | Self- | storage |
| | Compound | | Compound | | Compound | | | | | capacity | discharge | thickness |
| | of formula | a | of formula | b | of formula | c | m | W | T | retention | coefficient | change rate |
| Group | I | (%) | II | (%) | III | (%) | (%) | (mm) | (μm) | rate (%) | (mV/h) | (%) |
| Example | / | 0 | / | 0 | / | 0 | 50.35 | 10 | 10 | 86.80 | 0.021 | 37.50 |
| 1-25 | | | | | | | | | | | | |
| Example | Compound | 0.01 | / | 0 | / | 0 | 50.35 | 10 | 10 | 87.50 | 0.02 | 33.80 |
| 2-1 | I-1 | | | | | | | | | | | |
| Example | Compound | 0.01 | / | 0 | / | 0 | 50.35 | 10 | 10 | 87.40 | 0.02 | 33.50 |
| 2-2 | I-2 | | | | | | | | | | | |
| Example | Compound | 0.01 | / | 0 | / | 0 | 50.35 | 10 | 10 | 87.55 | 0.02 | 33.10 |
| 2-3 | I-3 | | | | | | | | | | | |
| Example | Compound | 0.1 | / | 0 | / | 0 | 50.35 | 10 | 10 | 87.80 | 0.019 | 31.80 |
| 2-4 | I-3 | | | | | | | | | | | |
| Example | Compound | 0.5 | / | 0 | / | 0 | 50.35 | 10 | 10 | 87.92 | 0.019 | 31.30 |
| 2-5 | I-3 | | | | | | | | | | | |
| Example | Compound | 1 | / | 0 | / | 0 | 50.35 | 10 | 10 | 87.60 | 0.02 | 31.70 |
| 2-6 | I-3 | | | | | | | | | | | |
| Example | / | 0 | / | 0 | Compound | 0.1 | 50.35 | 10 | 10 | 87.84 | 0.02 | 25.60 |
| 2-7 | | | | | III-1 | | | | | | | |
| Example | / | 0 | / | 0 | Compound | 0.1 | 50.35 | 10 | 10 | 87.82 | 0.02 | 25.80 |
| 2-8 | | | | | III-4 | | | | | | | |
| Example | / | 0 | / | 0 | Compound | 0.1 | 50.35 | 10 | 10 | 87.90 | 0.02 | 24.70 |
| 2-9 | | | | | III-8 | | | | | | | |
| Example | / | 0 | / | 0 | Compound | 0.5 | 50.35 | 10 | 10 | 88.00 | 0.02 | 24.50 |
| 2-10 | | | | | III-8 | | | | | | | |
| Example | / | 0 | / | 0 | Compound | 1 | 50.35 | 10 | 10 | 88.05 | 0.02 | 24.10 |
| 2-11 | | | | | III-8 | | | | | | | |
| Example | / | 0 | / | 0 | Compound | 3 | 50.35 | 10 | 10 | 87.85 | 0.02 | 24.15 |
| 2-12 | | | | | III-8 | | | | | | | |
| Example | / | 0 | Compound | 0.01 | / | 0 | 50.35 | 10 | 10 | 87.62 | 0.02 | 30.20 |
| 2-13 | | | II-1 | | | | | | | | | |
| Example | / | 0 | Compound | 0.01 | / | 0 | 50.35 | 10 | 10 | 87.56 | 0.02 | 30.50 |
| 2-14 | | | II-5 | | | | | | | | | |
| Example | / | 0 | Compound | 0.01 | / | 0 | 50.35 | 10 | 10 | 87.65 | 0.02 | 30.00 |
| 2-15 | | | II-7 | | | | | | | | | |
| Example | / | 0 | Compound | 0.05 | / | 0 | 50.35 | 10 | 10 | 87.77 | 0.02 | 29.88 |
| 2-16 | | | II-7 | | | | | | | | | |
| Example | / | 0 | Compound | 0.1 | / | 0 | 50.35 | 10 | 10 | 87.89 | 0.02 | 29.67 |
| 2-17 | | | III-7 | | | | | | | | | |
| Example | / | 0 | Compound | 0.3 | / | 0 | 50.35 | 10 | 10 | 87.85 | 0.02 | 29.71 |
| 2-18 | | | II-7 | | | | | | | | | |
| Example | / | 0 | / | 0 | / | 0 | 30.01 | 10 | 10 | 87.30 | 0.021 | 36.20 |
| 2-19 | | | | | | | | | | | | |
| Example | / | 0 | / | 0 | / | 0 | 38.22 | 10 | 10 | 87.10 | 0.021 | 36.90 |
| 2-20 | | | | | | | | | | | | |
| Example | / | 0 | / | 0 | / | 0 | 45.46 | 10 | 10 | 87.00 | 0.021 | 37.10 |
| 2-21 | | | | | | | | | | | | |
| Example | / | 0 | / | 0 | / | 0 | 56.02 | 10 | 10 | 86.20 | 0.022 | 38.50 |
| 2-22 | | | | | | | | | | | | |
| Example | / | 0 | / | 0 | / | 0 | 50.35 | 15 | 10 | 87.10 | 0.02 | 37.20 |
| 2-23 | | | | | | | | | | | | |
| Example | / | 0 | / | 0 | / | 0 | 50.35 | 20 | 10 | 87.20 | 0.02 | 36.90 |
| 2-24 | | | | | | | | | | | | |
| Example | / | 0 | / | 0 | / | 0 | 50.35 | 25 | 10 | 87.50 | 0.02 | 36.80 |
| 2-25 | | | | | | | | | | | | |
| Example | / | 0 | / | 0 | / | 0 | 50.35 | 10 | 20 | 87.00 | 0.02 | 36.95 |
| 2-26 | | | | | | | | | | | | |
| Example | / | 0 | / | 0 | / | 0 | 50.35 | 10 | 30 | 87.20 | 0.02 | 37.05 |
| 2-27 | | | | | | | | | | | | |
| Example | / | 0 | / | 0 | / | 0 | 50.35 | 10 | 40 | 87.30 | 0.02 | 36.70 |
| 2-28 | | | | | | | | | | | | |
| Example | / | 0 | / | 0 | / | 0 | 50.35 | 10 | 50 | 87.10 | 0.02 | 36.67 |
| 2-29 | | | | | | | | | | | | |
| Example | Compound | 0.5 | Compound | 0.16 | Compound | 1.2 | 42.11 | 17 | 30 | 90.50 | 0.017 | 15.20 |
| 2-30 | I-2 | | II-5 | | III-4 | | | | | | | |
| Example | Compound | 0.5 | Compound | 0.15 | Compound | 1.5 | 40.94 | 16 | 35 | 90.80 | 0.016 | 14.80 |
| 2-31 | I-2 + | | II-2 + | | III-4 + | | | | | | | |
| | compound | | compound | | compound | | | | | | | |
| | I-4 | | II-5 | | III-6 | | | | | | | |

*In the foregoing table, for Example 2-31, the mass ratio of compound I-2 to compound I-4 is 1:1, the mass ratio of compound II-2 to compound II-5 is 1:1, and the mass ratio of compound III-4 to compound III-6 is 1:1.

As can be seen from Table 2, for the lithium-ion batteries prepared in the examples of the present application, when the non-aqueous electrolyte further includes a compound of formula I and its mass percentage satisfies 0.01≤a≤1, the lithium-ion batteries have a superior cycling capacity retention rate and a lower high-temperature storage thickness change rate. In particular, for the lithium-ion batteries prepared in the examples of the present application, when the non-aqueous electrolyte further includes a compound of formula II and its mass percentage satisfies 0.01≤b≤0.3, the lithium-ion batteries have a superior cycling capacity retention rate and a lower high-temperature storage thickness change rate. In particular, for the lithium-ion batteries prepared in the examples of the present application, when the non-aqueous electrolyte further includes a compound of formula III and its mass percentage satisfies 0.1≤c≤3, the lithium-ion batteries have a superior cycling capacity retention rate and a lower high-temperature storage thickness change rate. In particular, for the lithium-ion batteries prepared in the examples of the present application, when the mass percentage of nickel element in the positive electrode active material layer satisfies 30≤m≤56, the lithium-ion batteries have a superior cycling capacity retention rate and a lower high-temperature storage thickness change rate. In particular, for the lithium-ion batteries prepared in the examples of the present application, when the width of the adhesive tape satisfies 10≤W≤25, the lithium-ion batteries have a superior cycling capacity retention rate and a lower high-temperature storage thickness change rate. In particular, for the lithium-ion batteries prepared in the examples of the present application, when the thickness of the adhesive tape substrate satisfies 10≤T≤50, the lithium-ion batteries have a superior cycling capacity retention rate and a lower high-temperature storage thickness change rate.

The foregoing descriptions are merely preferred embodiments of the present application and are not intended to limit the present application. Any modifications, equivalent substitutions, and improvements made within the spirit and principles of the present application shall be included within the protection scope of the present application.

What is claimed is:

1. A non-aqueous electrolyte, wherein the non-aqueous electrolyte comprises a first substance and a second substance;
the first substance comprises at least one of dimethyl carbonate or ethyl acetate; and based on a total mass of the non-aqueous electrolyte, a mass percentage of the first substance is M₁%, wherein 50≤M₁≤70; and
the second substance comprises at least one of succinonitrile, glutaronitrile, or adiponitrile; and based on the total mass of the non-aqueous electrolyte, a mass percentage of the second substance is M₂%, wherein 0.01≤M₂≤3.

2. The non-aqueous electrolyte according to claim 1, wherein the non-aqueous electrolyte satisfies at least one of the following conditions:
$$55 \leq {M}_{1} \leq 65 ; or \qquad ( 1 )$$
$$0.1 \leq {M}_{2} \leq 2. \qquad ( 2 )$$

3. The non-aqueous electrolyte according to claim 1, wherein the non-aqueous electrolyte further comprises ethylene carbonate; and
based on the total mass of the non-aqueous electrolyte, a mass percentage of the ethylene carbonate is M₃%, wherein 5≤M₃≤30.

4. The non-aqueous electrolyte according to claim 1, wherein the non-aqueous electrolyte further comprises a third substance; the third substance comprising at least one of lithium tetrafluoroborate, lithium bis(oxalate)borate, lithium difluoro(oxalate)borate, sodium tetrafluoroborate, sodium bis(oxalate)borate, sodium difluoro(oxalate)borate, potassium tetrafluoroborate, potassium bis(oxalate)borate, potassium difluoro(oxalate)borate, cesium tetrafluoroborate, cesium bis(oxalate)borate, or cesium difluoro(oxalate)borate; and
based on the total mass of the non-aqueous electrolyte, a mass percentage of the third substance is M₄%, wherein 0.001≤M₄≤0.5.

5. The non-aqueous electrolyte according to claim 1, wherein the non-aqueous electrolyte further comprises a compound of formula I: 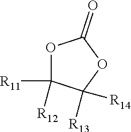
compound of formula I;
wherein R₁₁, R₁₂, R₁₃, and R₁₄ are each independently selected from a hydrogen atom, a fluorine atom, a C₁ to C₃ alkyl group, or a fluorine-substituted C₁ to C₃ alkyl group, and at least one of R₁₁, R₁₂, R₁₃, or R₁₄ is a fluorine atom; and
based on the total mass of the non-aqueous electrolyte, a mass percentage of the compound of formula I is a %, wherein 0.01≤a≤1.

6. The non-aqueous electrolyte according to claim 5, wherein the compound of formula I comprises at least one of the following compounds:

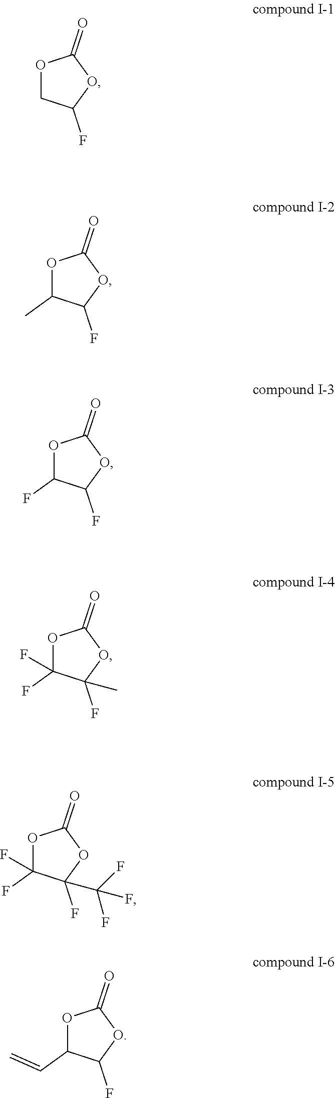

7. The non-aqueous electrolyte according to claim 1, wherein the non-aqueous electrolyte further comprises a compound of formula II: 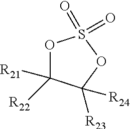
compound of formula II;
wherein R₂₁, R₂₂, R₂₃, and R₂₄ are each independently selected from at least one of a hydrogen atom, a fluorine atom, or an unsubstituted or fluorine-substituted methyl group, ethyl group, n-propyl group, isopropyl group, vinyl group, or ethynyl group; and
based on the total mass of the non-aqueous electrolyte, a mass percentage of the compound of formula II is b %, wherein 0.01≤b≤0.3.

8. The non-aqueous electrolyte according to claim 7, wherein the compound of formula II comprises at least one of the following compounds:

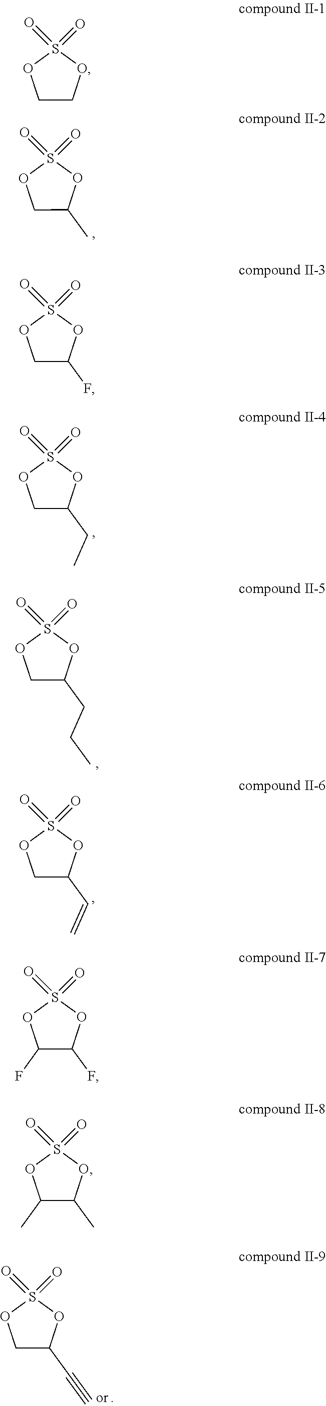

9. The non-aqueous electrolyte according to claim 1, wherein the non-aqueous electrolyte further comprises a compound of formula III: 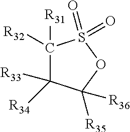
compound of formula III;
wherein R₃₁, R₃₂, R₃₃, R₃₄, R₃₅, and R₃₆ are each independently selected from a hydrogen atom, a fluorine atom, a C₁ to C₃ alkyl group, or a fluorine-substituted C₁ to C₃ alkyl group; and
based on the total mass of the non-aqueous electrolyte, a mass percentage of the compound of formula III is c %, wherein 0.1≤c≤3.

10. The non-aqueous electrolyte according to claim 9, wherein the compound of formula III comprises at least one of the following compounds:

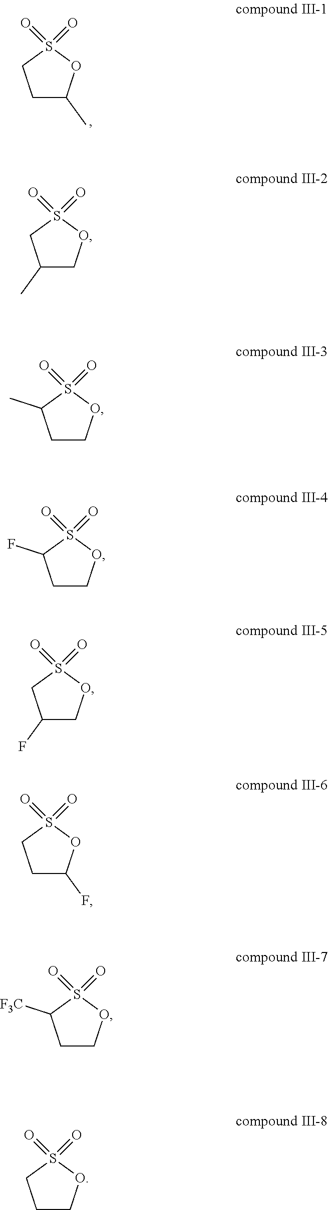

11. An electrochemical apparatus, comprising an electrode assembly and an non-aqueous electrolyte;
the non-aqueous electrolyte comprises a first substance and a second substance;
the first substance comprises at least one of dimethyl carbonate or ethyl acetate; and based on a total mass of the non-aqueous electrolyte, a mass percentage of the first substance is M1%, wherein 50≤M1≤70; and
the second substance comprises at least one of succinonitrile, glutaronitrile, or adiponitrile; and based on the total mass of the non-aqueous electrolyte, a mass percentage of the second substance is M2%, wherein 0.01≤M2≤3;
the electrode assembly comprises a positive electrode, a separator, and a negative electrode that are sequentially stacked and wound; and the positive electrode comprises a positive electrode current collector and a positive electrode active material layer provided on at least one surface of the positive electrode current collector; the positive electrode active material layer comprising nickel element;
based on a total mass of the positive electrode active material layer, a mass percentage of the nickel element is m %, wherein 30≤m≤56.

12. The electrochemical apparatus according to claim 11, wherein the outermost turn of the electrode assembly has a terminating section; the electrode assembly comprises an adhesive tape, the adhesive tape being adhered to the terminating section; and the width of the adhesive tape is W mm, wherein 10≤W≤25.

13. The electrochemical apparatus according to claim 12, wherein the adhesive tape comprises a substrate and an adhesive layer; and the thickness of the substrate is T μm, wherein 10≤T≤50.

14. The electrochemical apparatus according to claim 11, wherein the non-aqueous electrolyte satisfies at least one of the following conditions:
$$55 \leq {M}_{1} \leq 65 ; or \qquad ( 1 )$$
$$0.1 \leq {M}_{2} \leq 2. \qquad ( 2 )$$

15. The electrochemical apparatus according to claim 11, wherein the non-aqueous electrolyte further comprises ethylene carbonate; and
based on the total mass of the non-aqueous electrolyte, a mass percentage of the ethylene carbonate is M3%, wherein 5≤M3≤30.

16. The electrochemical apparatus according to claim 11, wherein the non-aqueous electrolyte further comprises a third substance; the third substance comprising at least one of lithium tetrafluoroborate, lithium bis(oxalate)borate, lithium difluoro(oxalate)borate, sodium tetrafluoroborate, sodium bis(oxalate)borate, sodium difluoro(oxalate)borate, potassium tetrafluoroborate, potassium bis(oxalate)borate, potassium difluoro(oxalate)borate, cesium tetrafluoroborate, cesium bis(oxalate)borate, or cesium difluoro(oxalate)borate; and
based on the total mass of the non-aqueous electrolyte, a mass percentage of the third substance is M4%, wherein 0.001≤M4≤0.5.

17. The electrochemical apparatus according to claim 11, wherein the non-aqueous electrolyte further comprises a compound of formula I: 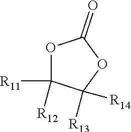
compound of formula I;
wherein R₁₁, R₁₂, R₁₃, and R₁₄ are each independently selected from a hydrogen atom, a fluorine atom, a C₁ to C₃ alkyl group, or a fluorine-substituted C₁ to C₃ alkyl group, and at least one of R₁₁, R₁₂, R₁₃, or R₁₄ is a fluorine atom; and
based on the total mass of the non-aqueous electrolyte, a mass percentage of the compound of formula I is a %, wherein 0.01≤a≤1;
the compound of formula I comprises at least one of the following compounds:

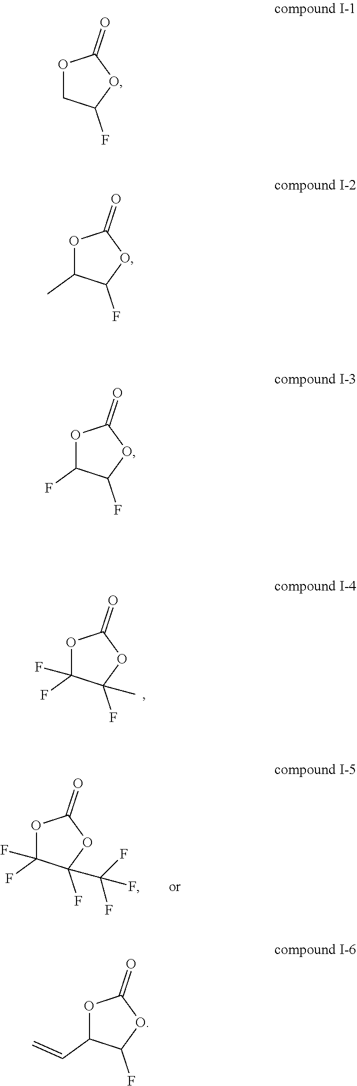

18. The electrochemical apparatus according to claim 11, wherein the non-aqueous electrolyte further comprises a compound of formula II: 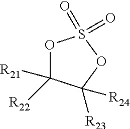
compound of formula II;
wherein R₂₁, R₂₂, R₂₃, and R₂₄ are each independently selected from at least one of a hydrogen atom, a fluorine atom, or an unsubstituted or fluorine-substituted methyl group, ethyl group, n-propyl group, isopropyl group, vinyl group, or ethynyl group;
based on the total mass of the non-aqueous electrolyte, a mass percentage of the compound of formula II is b %, wherein 0.01≤b≤0.3; and
the compound of formula II comprises at least one of the following compounds:

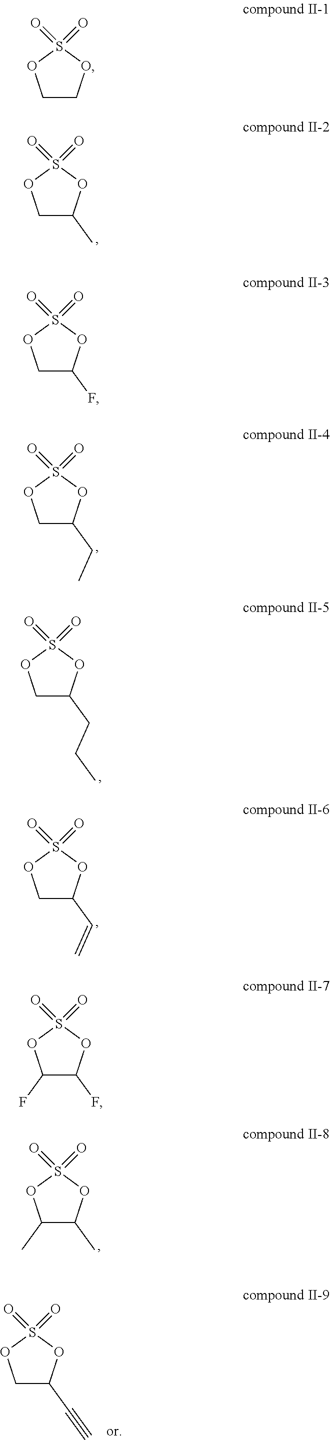

19. The electrochemical apparatus according to claim 11, wherein the non-aqueous electrolyte further comprises a compound of formula III: 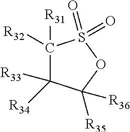
compound of formula III;
wherein R₃₁, R₃₂, R₃₃, R₃₄, R₃₅, and R₃₆ are each independently selected from a hydrogen atom, a fluorine atom, a C₁ to C₃ alkyl group, or a fluorine-substituted C₁ to C₃ alkyl group;
based on the total mass of the non-aqueous electrolyte, a mass percentage of the compound of formula III is c %, wherein 0.1≤c≤3; and
the compound of formula III comprises at least one of the following compounds:

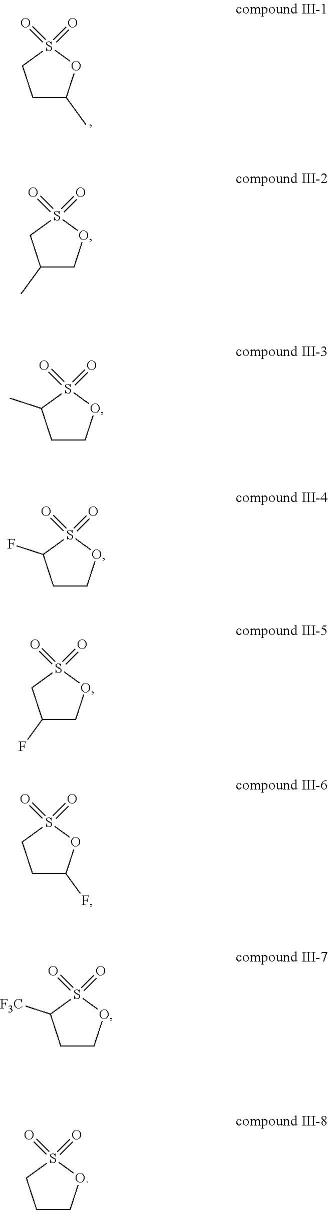

20. An electronic apparatus, comprising an electrochemical apparatus, the electrochemical apparatus comprises an electrode assembly and an non-aqueous electrolyte;
the non-aqueous electrolyte comprises a first substance and a second substance;
the first substance comprises at least one of dimethyl carbonate or ethyl acetate; and based on a total mass of the non-aqueous electrolyte, a mass percentage of the first substance is M1%, wherein 50≤M1≤70; and
the second substance comprises at least one of succinonitrile, glutaronitrile, or adiponitrile; and based on the total mass of the non-aqueous electrolyte, a mass percentage of the second substance is M2%, wherein 0.01≤M2≤3;
the electrode assembly comprises a positive electrode, a separator, and a negative electrode that are sequentially stacked and wound; and the positive electrode comprises a positive electrode current collector and a positive electrode active material layer provided on at least one surface of the positive electrode current collector; the positive electrode active material layer comprising nickel element; and
based on a total mass of the positive electrode active material layer, a mass percentage of the nickel element is m %, wherein 30≤m≤56.
